(19) United States
(12) Patent Application Publication
(10) Pub. No.: US 2007/0056989 A1
(43) Pub. Date: Mar. 15, 2007

(54) HAIR DYE HAVING LARGER CENTERED CONTAINERS

(76) Inventor: Peter Adema, Zundert (NL)

Correspondence Address: ADAM K. SACHAROFF;MUCH SHELIST FREED DENENBERG AMENT&RUBENSTEIN,PC, 191 N. WACKER DRIVE, SUITE 1800, CHICAGO, IL, 60606-1615, US

(21) Appl. No.: 11/556,387

(22) Filed: Nov. 3, 2006

Related U.S. Application Data
(63) Continuation of application No. 10/733,148, filed on Dec. 12, 2003, now abandoned.

(30) Foreign Application Priority Data
Jul. 19, 2001 (WO) PCT/NL01/00554
Jul. 19, 2001 (NL) 1015747
Jun. 8, 2001 (NL) 1018245

(51) Int. Cl. B67D 5/60

(52) U.S. Cl. 222/144

(57) ABSTRACT

An apparatus for dispensing a plurality of fluids having a turntable, and a plurality of pumps, each connected to a container. The pumps and containers are mounted on the turntable arranged along the circumference of the turntable or part of the circumference of the turntable. At least one of the containers has a larger volume than the other containers or is in fluid connection with a further container positioned towards or at the center of the turntable.

### CROSS-REFERENCE TO RELATED APPLICATIONS

This application is a continuation application of U.S. application Ser. No. 10/733,148 filed Dec. 12, 2003 which is a continuation of International PCT Application Serial No.: PCT/NL01/00554 filed Jul. 19, 2001.

### BACKGROUND OF THE INVENTION

The invention relates to a system for dispensing portions of various substances. The invention also relates to the creation of a mixture of the portions of various substances, in particular working on the basis of a formulation. The invention also relates to the application of the substances or mixtures to a surface or object. The invention also relates to related matters, such as the provision of information to the user of the substances and to the producer (s) of the substances. By way of example, the invention relates to measures which ensure that there is always a sufficient stock of the substances and that the producer gains an up-to-date insight into the demand for the various substances. The invention relates in particular to the dispensing of substances which are intended for the treatment of the hair or skin of people.

In particular, a preferred application area of the invention is the field of dyeing hair. The various aspects of the invention will be explained in the following introduction and in the description of the figures on the basis of a preferred application area of the invention, namely that of dyeing hair. It will be clear that various aspects of the invention can also advantageously be applied to other, even completely different, application areas. In this context, the following application areas may be mentioned in particular, although this is by no means a list which constitutes any form of limitation: cosmetics, skin and hair care products, including hair dye, medical products, industrial greases and lubricants, foodstuffs (sauces, soups), etc. A system for dispensing portions of various substances in order to make up a hair-dye mixture in a hairdressing salon is known, for example, from DE 41 13 454 (Wella).

The device which is known from DE 41 13 454 has a frame in which there is a moveable magazine which is provided with a plurality of receiving stations which are each designed to receive an exchangeable storage container which has a storage chamber filled with a substance. Most exchangeable storage containers are filled with a highly viscous hair-dye substance of a defined color composition for dyeing the hair of the customer. Furthermore, one or more storage containers holding hydrogen peroxide or the like can be positioned in the magazine. This known device is also provided with drive means for moving the magazine, in such a manner that one of the storage containers can be moved to a dispensing station of the device in order to dispense substance into a collection container arranged at the dispensing station. After a plurality of substances have been dispensed into the collection container, generally including a portion of hydrogen peroxide, the hairdresser has to mix the substances, and then the mixture is applied to the hair. A spatula or the like which can be held in the hand is usually used for mixing and applying the mixture to the hair.

The system which is known from DE 41 13 454 has a number of drawbacks. One drawback of the system which is known from DE 41 13 454 is the use of storage containers which are designed to be under pressure or to be pressurized in order to dispense the hair-dye substance. When making up a hair-dye mixture, relatively accurate control of the quantity of each of the components of the mixture is required. Valve-controlled dispensing of a substance from the storage chamber under the influence of gas or air pressure makes correct metering difficult, primarily because, for example, the viscosity of the hair dye may have a significant influence on the way in which it flows out during this method of dispensing. Consequently, this known system requires an accurate and therefore expensive weighing device to determine how much substance has been dispensed into the collection container.

Another system for making up a hair-dye mixture in a hairdressing salon is known from U.S. Pat. No. 6,089,408. This known system provides for the use of storage containers with a storage chamber which is delimited by a transparent, cylindrical circumferential wall. At one end, there is a dispensing channel provided with an associated self-closing valve in the dispensing channel, at a distance towards the inside with respect to the dispensing nozzle. The storage chamber is also delimited by a piston which can be moved by hand and bears in a sealed manner against the inner side of the circumferential wall. When a hair dye mixture is to be made up, the hairdresser in each case presses the required quantity of substance out of a storage container; the hairdresser can use the transparent circumferential wall to determine how much substance has been dispensed. It will be clear that the system which is known from U.S. Pat. No. 6,089,408 is inaccurate when metering a portion of a substance and, moreover, is cumbersome to use.

### SUMMARY OF THE INVENTION

A first aspect of the invention provides an improvement to the way in which substance is removed from the storage container, particularly with regard to the desired accuracy, by creating a system according to claim 1. The dispensing nozzle may be integral with the pump or can be coupled to the pump. The pump may form an integral unit with the storage container. By way of example, the unit is of a disposable design.

In another embodiment, the pump can be releasably coupled to the storage container. The pump may optionally be releasably mounted in the device. Furthermore, it is possible to provide an adapter between the pump and from the storage container, in which case the adapter can be detached both from the pump and the storage container. By way of further example, at each receiving station there is a pump in the magazine, which can be coupled to a storage container. In a variant, there is a pump at the standing station for the collection container, which is then coupled to a storage container from which substance is dispensed.

A pump preferably has a pump chamber with a variable volume which, via a suction valve of the pump, is connected to the storage chamber of the storage container. In this case, a preferably self-closing valve assembly may be provided at the dispensing nozzle and then serves as the delivery valve of the pump. Preferably, the pump is such that, each time it is actuated, it dispenses a small quantity of the substance, so that the number of pump actuations is representative of the quantity of substance which has been dispensed.

In one possible embodiment, the storage container, for example for the hair dye, may comprise a bag which is filled with substance and is accommodated in a stable housing. In this case, because of the hair dye being highly sensitive to oxidation, the bag is preferably provided with an airtight layer of (metal) foil. In this case too, it is possible to use a pump to remove the contents from the bag.

In another embodiment, the storage container may have a storage chamber which is made from metal, for example aluminum, in order in this way to optimally protect the substance, for example in the case of hair dye which is highly sensitive to oxidation.

In a further variant, the storage-chamber wall is made from plastic with a layer of metal or a metal coating to make it airtight.

In yet another variant, the storage containers used are the known metal tubes with a screw cap at one end and a closed seam at the other end. A storage container of this type can then be screwed onto a pump. If a pump is not being used, the dispensing device may be provided with one or more mechanisms for squeezing the tube empty.

Another drawback of the abovementioned known systems is that hair-dye substance, which is generally oxidized quickly when exposed to air, may dry out and harden in the dispensing channel. This may cause partial or complete blockage of the dispensing channel. A second aspect of the invention solves this problem.

A third aspect of the invention provides a system that includes volume-detection means are present for the purpose of detecting the volume in the storage containers. If metering out of the storage container is effected by means of a pump, the volume detection can be used, for example, to stop the pump when sufficient substance has been dispensed.

By way of example, it is possible for the wall of the storage container to be transparent at least along a strip thereof and for the volume-detection means to comprise an optical sensor which detects the volume, for example the position of the piston of the storage container, through the transparent wall.

In a variant, acoustic detection means are used to detect the volume in the storage containers. The system preferably comprises a memory, for example of an electronic control unit associated with the system, in which the results of the volume detection are stored, so that the current volume of substance is available for each storage container. By way of example, this can be used to signal that a storage container is empty, to determine the rate at which each substance is used, to determine the extent to which new stocks of substances need to be ordered from the supplier (automatically if appropriate) in conjunction with any stock control system, etc.

In the system which is known from DE 41 13 454, all the exchangeable storage containers are identical in form, and the storage containers can be positioned at any receiving station in the magazine. Then, optically or electrically readable coding means on the storage containers are used to determine which storage container has been positioned at which location in the magazine.

A fourth aspect of the invention provides a mechanical way of determining the position of a storage container in the magazine. For this purpose, a system is provided with a key formation defined on the storage containers containing a defined substance has a specific, unique form which is representative of the said substance. Consequently, a storage container of this type only fits into the receiving station which is provided with a complementary key formation.

In the abovementioned known system, there are scarcely any measures provided which ensure safety and working conditions, for example in view of the harmful nature of the substances used in a hair-dye mixture.

A fifth aspect of the present invention provides a system avoid contamination of the device with the substances and prevents contact, when used in a hairdressing salon, between the hairdresser and the hair-dye mixture or exposure to vapors from the hair-dye mixture.

The known systems do not provide any solution to the problem that a collection container is contaminated and disposed of after use, which is a drawback for environmental reasons. However, cleaning the collection container, particularly if this takes place by hand, is time-consuming and may lead to undesirable contact with the substances and exposure to vapors. To resolve the above drawback, a sixth aspect of the invention provides a system with a lining. This only contaminates the lining, while in principle the outer shell remains clean. The lining is preferably disposable, so that no cleaning is required. By way of example, the covering is in the form of a thin-walled plastic receptacle or a sheet. The covering is preferably easily compressible, so that the volume of waste can be reduced considerably with respect to the volume of the outer shell.

Although the abovementioned known systems do allow a plurality of substances to be dispensed into a collection container, they do not provide for mixing of the said substances.

A seventh aspect of the present invention provides a system which direct mixing of a highly viscous substance is possible, on the one hand, for example a hair-dye substance, with a low-viscosity substance, on the other hand, for example hydrogen peroxide, is possible.

An eighth aspect of the invention provides for cleaning of the dispensing nozzle, via which nozzle a highly viscous substance, for example hair dye of a defined color composition, is dispensed from a storage container. Particularly in the case of substances which oxidize, it is desirable for no residues to remain at the dispensing nozzle, which could block the nozzle or lead to oxidized substance forming part of a subsequent portion.

A ninth aspect of the invention relates to the practical problem that, depending on hair fashion, a plurality of hair-dye mixtures with different color compositions or of different quality (for example depending on the quality of the hair) are required to treat the hair of a customer by dyeing the hair.

A tenth aspect of the invention relates to the application of the substances or the mixtures of substances to the intended surface, for example to the hair of the customer. The abovementioned known systems do not offer any features which allow efficient operation. Also, the known method of application of, in particular, a hair-dye mixture has the drawback that the hairdresser can easily come into contact with the mixture.

An eleventh aspect of the invention relates to the safety and working conditions of the users of the system. In the known systems, it is possible for substance to be dispensed from a storage container while there is no collection container in order to collect the substance. According to the eleventh aspect of the invention, this problem is solved by only allowing hair dye to be dispensed when it is ensured that the hair dye dispensed enters the collection container. Particularly because its oxidizing nature, it is undesirable for spilled hair dye to have to be removed by the staff of the hairdressing salon. Preferably, there is provision for the drive means of the magazine to be inoperative if there is no collection container at the dispensing station.

A twelfth aspect of the invention provides a system which provides protection against the hand or finger(s) being caught in the moving parts of the device. This is achieved by the fact that the device has a housing in which there is an opening for positioning a collection container at the dispensing station, and by the fact that the dimensions of the collection container with respect to the said opening are such that it is impossible for the hand or one or more fingers to gain access to the interior of the housing if the collection container is arranged at the intended location.

A thirteenth aspect of the invention relates to the stirring of the substances in the collection container in order to obtain the desired mixture. The abovementioned known systems do not offer any solution to this, and consequently the hairdresser himself has to stir them, using a spatula or brush. This is inefficient.

A fourteenth aspect relates to the problem that the abovementioned known systems do not provide sufficient time savings for the hairdresser, which time savings are highly important for the profitability of the hairdressing salon. The fourteenth aspect of the present invention provides a system, which already allows considerable time saving to be achieved and errors in the formulations to be prevented. To allow the skill and creativity of the user, in particular the hairdresser, to manifest themselves, adjustment means are preferably provided. For example, the hairdresser knows that the use of medicines, illnesses and hormones may have a relevant influence on a hair-dyeing treatment. Preferably, the correct formulation is chosen or pre-selected automatically on the basis of the results of an analysis, for example a hair or skin analysis. The skin analysis may comprise pH measurement, moisture measurement and/or fat measurement. Another variable is that, for example, a hairdresser needs a historical overview of the dyeing treatment which a certain customer has previously undergone. For this purpose, it is possible to provide a logbook memory.

In a further advantageous embodiment of the fourteenth aspect of the invention, a diary is provided, for example in a computer which forms part of the system, in which the planned dispensing deliveries of formulations are planned or from which the expected dispensing deliveries can be derived, for example on the basis of the name of the customer in the hairdressing salon and the information associated with the said customer in a logbook memory of the system. The diary function then offers the option of, for example, checking whether the substances which are (probably) required are present in sufficient quantities in the device and/or in an additional storage magazine. If there is insufficient stock of the substances, signaling may then take place, which is optionally automatically transmitted via a network connection to the supplier of the substances.

Another problem is that in practice the customer often wants a different dyeing or skin treatment from that which is advised. The present invention provides a solution to this situation which in particular protects the person effecting the treatment from liability in such a situation. In the field of hair dye, it is an important fact that fashion, the season, etc. have considerable influence on the demand for different color compositions. The manufacturer of the hair dye has a great need for an accurate insight into this demand. A fifteenth aspect of the invention provides for supplying relevant information in order to estimate this demand correctly.

A sixteenth aspect of the invention relates to the interaction between the user, for example the hairdresser, and firstly the system and secondly, for example, the customer to be treated. It is desirable for the user to be able to remain with his customer during the dispensing of the substances and preferably also during production of the mixture. This saves time and is more appealing to the customer.

A seventeenth aspect of the invention relates to the stock control of the substances which are to be dispensed.

An eighteenth aspect of the present invention relates to a self-closing valve assembly with a container with a pump provided with a valve assembly of this type.

DE 40 35 922 and U.S. Pat. No. 5,819,990 have disclosed containers with an integral pump which can be used to pump the substance out of the storage chamber of the container and to dispense them at a dispensing aperture. In these known containers, a self-closing valve assembly is arranged at the location of the dispensing aperture. When the pump is actuated, the pressure of the substance opens the valve assembly, after which the valve assembly closes automatically.

These known containers have not proven entirely satisfactory. For example, one drawback is that the valve assemblies of these known containers do not always have the desired closing action. Consequently, the known containers are, for example, (relatively) unsuitable for dispensing substances which are highly susceptible to oxidation, such as for example hair dye. Furthermore, the known valve assemblies are difficult to produce if it is desired to achieve a good closing action.

Another drawback relates to the design of the known containers, which is relatively complex, which is disadvantageous in particular for disposable containers. The eighteenth aspect of the invention aims to provide an improved self-closing valve assembly and a container with a pump provided with a valve assembly of this type. In particular, the eighteenth aspect of the invention provides for the use of a container of this type for dispensing hair dye. The eighteenth aspect of the present invention achieves the above object by providing a self-closing valve assembly.

### BRIEF DESCRIPTION OF THE DRAWINGS

Further inventive ideas and advantageous embodiments are described in the claims and the following description with reference to the drawing, in which:

FIG. 1 diagrammatically depicts a front view of a dispensing device, with the outer housing omitted, for dispensing metered portions of various substances, in particular hair-dye substances,

FIG. 2 shows a side view of the device from FIG. 1,

FIG. 3 shows a plan view of the device from FIG. 1,

FIG. 4 shows a longitudinal section through a telescopic pump component provided with a self-closing valve assembly according to the invention,

FIG. 5 shows a container with integral pump provided with the telescopic pump component from FIG. 4,

FIG. 6 shows a block diagram illustrating a preferred embodiment of the system according to the invention, comprising one or more dispensing devices, e.g. as shown for example in FIG. 1, an additional magazine, a network, a computer, a hair analysis appliance, a portable device for actuating the device and for reading a customer-specific information carrier,

FIG. 7 shows an exemplary embodiment of the system according to the invention with a collection container and with an application member in which the collection container can be accommodated,

FIG. 8a shows a first exemplary embodiment of a collection container with a plurality of compartments and the relevant part of the housing of the device,

FIG. 8b shows a second exemplary embodiment of a collection container with a plurality of compartments,

FIG. 8c shows the collection container from FIG. 8b provided with a key formation and the relevant part of the housing of the device,

FIG. 9a shows a collection container with a stirring member designed as a comb,

FIG. 9b shows a collection container with two stirring members, the stirring members being stationary and the collection container moving during the stirring,

FIG. 10 shows a collection container with a removable inner lining,

FIG. 11 shows a detailed view of the mixing of the hair-dye substance with hydrogen peroxide by direct contact between the flow of hair-dye substance and one or more jets of hydrogen peroxide,

FIG. 12 shows a detailed view of the cleaning of a dispensing nozzle with the aid of a jet of diluent in a cleaning station of the device,

FIG. 13 shows a storage container provided with an associated key formation, and

FIG. 14 shows a detail of a system according to the invention.

### DESCRIPTION OF THE INVENTION

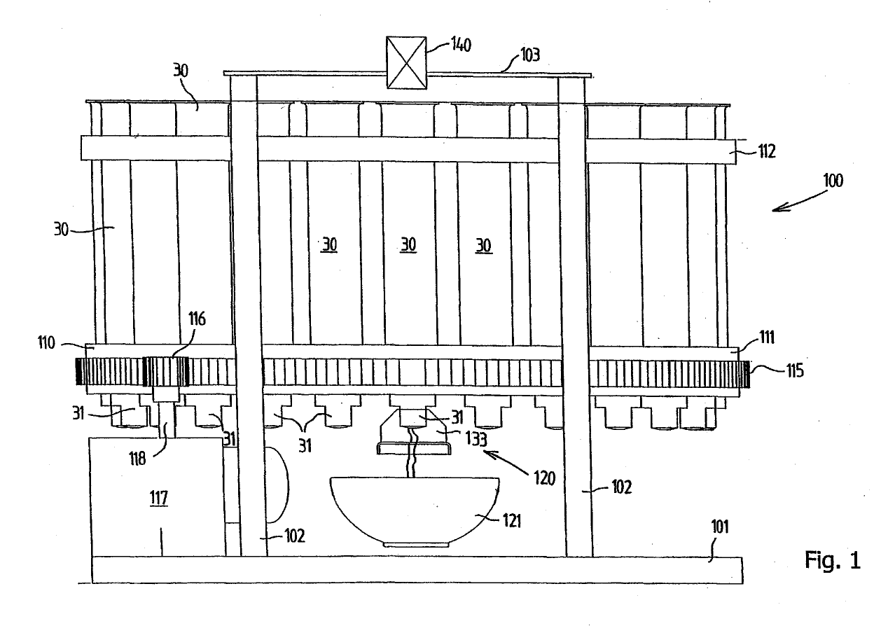

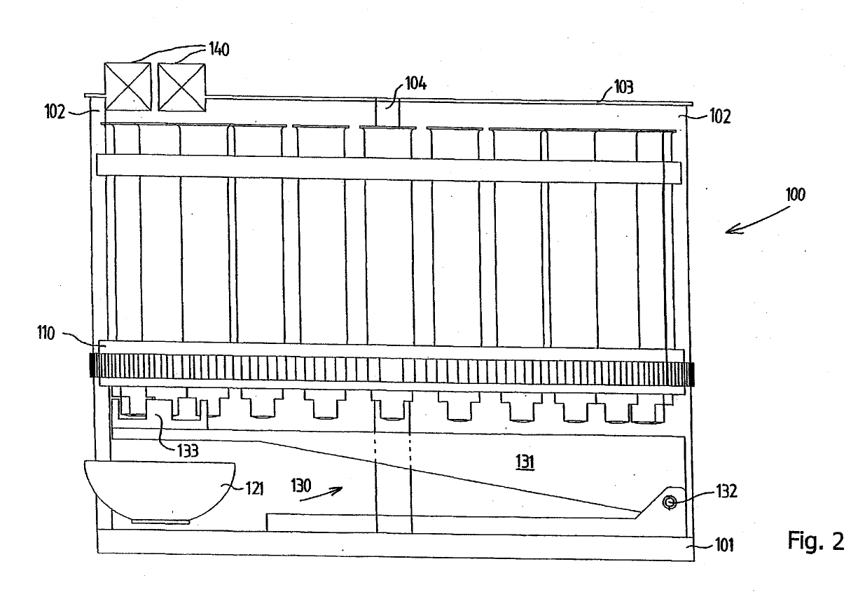

The text which follows explains a dispensing device 100 for dispensing metered portions of various substances, in particular hair dye, with reference to FIGS. 1, 2 and 3. The device 100 shown is intended in particular to be used in a hairdressing salon. The device 100 comprises a frame with a base plate 101, four uprights 102 and a cross 103 which connects the top ends of the uprights 102. Between the base plate 101 and the centre of the cross 103 there is a vertical spindle 104.

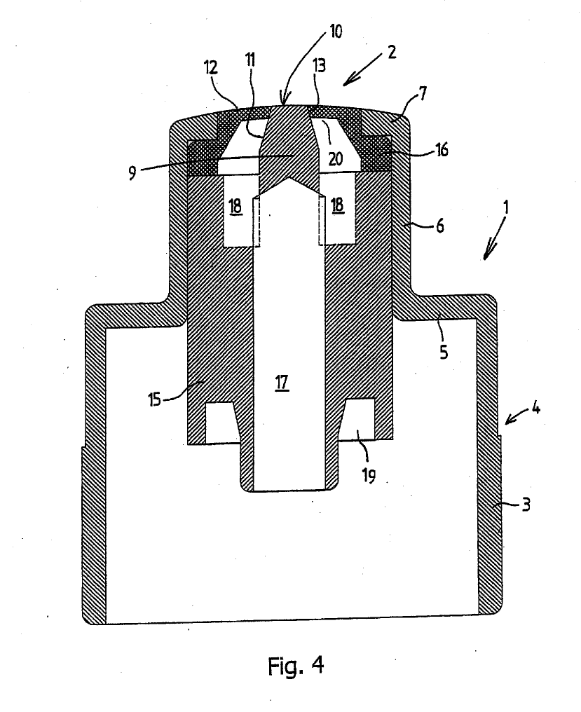

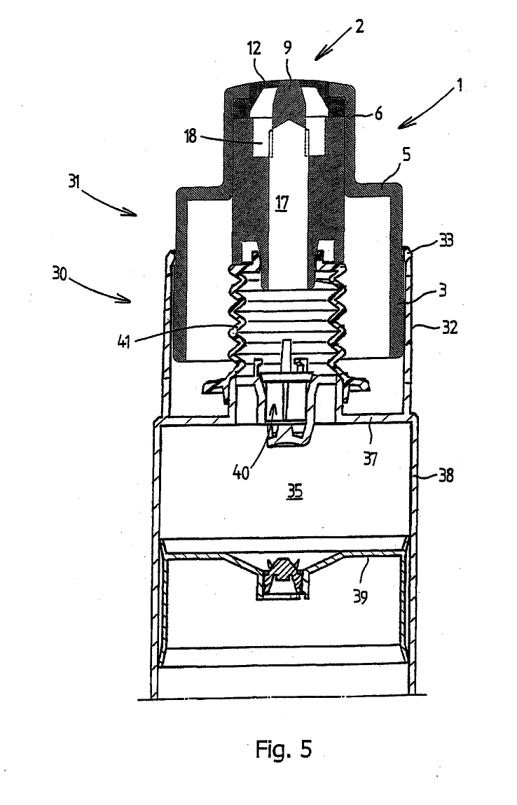

A rotatable magazine 110 with a bottom circular support 111 and a top support 112 is arranged around the spindle 104. In both supports 111, 112, there are a plurality of receiving stations in two concentric ring formations along the outer circumference, each intended to receive an exchangeable storage container 30 with integral pump 31 (which is shown in FIGS. 4 and 5). The receiving stations of the two ring formations are offset slightly in the circumferential direction with respect to one another.

The container 30 with pump 31 will be explained in more detail below. In this arrangement, the containers 30 fit into the magazine 110 with the pump 31 directed downwards, in such a manner that the fixed part of the container 30 is held in a stationary position with respect to the magazine 110 and the pump component 1 can be moved up and down. To be able to introduce and remove the containers 30, the housing (not shown) of the device 100 may be provided with an opening on the top side, which can be closed off by a cover or the like.

The bottom support 111 is provided, along its circumference, with a toothed ring 115 which meshes with a toothed wheel 116. The toothed wheel 116 is provided on a shaft 118 which is driven by an electric motor 117, preferably a stepper motor or a (direct) current motor with tachogenerator or pulse pick-up. The motor 117 is coupled to control means (not shown), in such a manner that in each case one of the storage containers 30 can be moved to a dispensing station 120 of the device 100 in order to dispense a portion of hair dye into a collection container 121 positioned at the dispensing station. Furthermore, in the centre of the magazine 110 there are four receiving stations 119 for larger containers, for example holding hydrogen peroxide.

The device 100 is provided with pump-actuating means 130 which are designed to actuate the pump 31 of a container 30 which has been positioned at the dispensing station as a result of the pump component 1 thereof being pushed upwards a desired number of times.

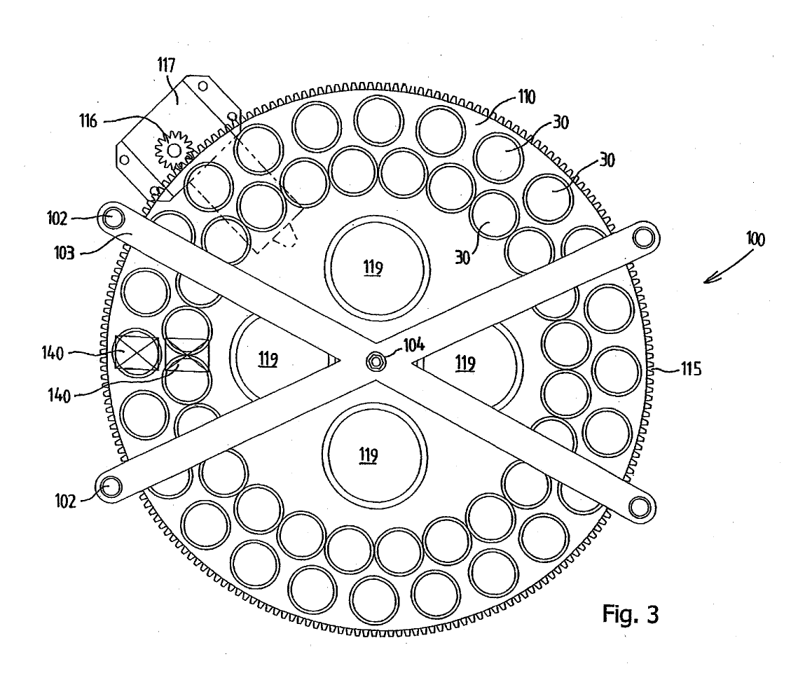

In this example, the pump-actuating means 130 comprise an arm 131 which is attached to the frame in such a manner that it can pivot about a horizontal pin 132. The free end, which can move up and down, of the arm 131 extends as far as below the dispensing station 120 of the containers 30 in the innermost and outermost rings of the magazine 110. At that end, the arm 131 is provided with an engagement member 133 with a central opening, in such a manner that the annular wall 6 of the container 30 can fit into the said opening while the engagement member 133, at diametrically opposite positions, bears against the annular wall 5 of the pump component 1. Then, when the engagement member 133 is pivoted upwards, a portion of hair dye leaving the dispensing aperture entering the collection container 121, as indicated in FIG. 3.

Suitabie drive means, for example a stepper motor with an eccentric cam which engages on the arm 131 at a distance from the pivot pin 132, may be provided for the purpose of pivoting the arm 131.

In a variant which is not shown, each pump 31 is not integral with the storage part of the container, but rather can be releasably coupled thereto. In this case, the storage part could also be formed, for example, by a bag or the like. In this case, the pumps 31 are preferably fitted releasably in the magazine 110, so that the pumps 31 can be detached so that they can be cleaned and the like.

The dispensing of hair dye by actuating the pump 31 once has proven to be highly constant and scarcely to vary under the influence of, for example, temperature changes. Consequently, the number of times which a pump 31 is actuated forms a good indication of the portion which has been dispensed. Therefore, the control means preferably comprise counting means for counting the number of times that a pump 31 is actuated.

Above the dispensing station 120 for the containers 30 in the innermost and outermost ring formations, there is in each case a sensor 140 for detecting the volume of the hair dye which is present in the containers 30.

The sensors 140 are each designed to detect the position of the piston 39 of the container 30. The sensors 140 may, for example, be of the type which employ optical triangulation or ultrasound.

In a variant, the peripheral wall 38 of the container 30 is transparent at least over a longitudinal strip thereof, and the volume-detection means comprise an optical sensor which detects the position of the piston 39 through the transparent peripheral wall.

In a variant, the bellows 41 is not present at the containers 30 and the pump component 1 is then not a pump component, but rather is fixed to and integral with the wall 32. In this case, the device 100 may be provided, above the dispensing station, with a pressure-exerting means for pressing the piston 39 downwards in order to dispense hair dye. The pressure-exerting means may be mechanical but may also operate using gas or air pressure.

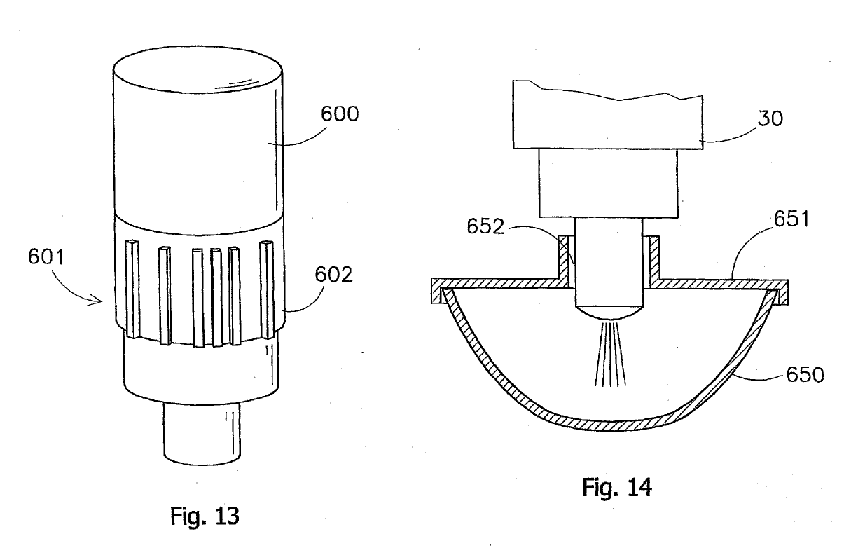

In a further variant as shown in FIG. 13, each storage container 600 is provided on its outer side with a key formation 601, which key formation is representative of the hair dye with which the storage container 600 is filled. Furthermore, the magazine 110 is provided at a receiving station thereof with a complementary key formation, if appropriate arranged in an exchangeable component, in such a manner that only a container 600 with the correct key formation can be positioned at the relevant receiving station.

In this case, there is preferably provision for each container 600 to be provided with the appropriate key formation 601 during the filling of the storage chamber, for example by fitting an annular body 602 which is provided with the key formation around the periphery of the storage container 600.

The device 100 is preferably used in combination with separate collection containers 121, in which case detection means are provided for detecting the presence of a collection container 121 at the dispensing station 120.

By using detection of this nature, it is possible, for example, to make the drive motor 117 of the magazine 110, and if appropriate also the pump-actuating means, inoperative if there is no collection container 121 at the dispensing station. This prevents hair dye from being dispensed, which would then contaminate the device 100.

At the side, the housing of the device 100 has an opening which makes it possible to arrange a collection container 121 at the dispensing station 120. In this case, it is preferable for the dimensions of the collection container 121 with respect to the said opening to be such that it is impossible for the hand or one or more fingers to gain access to the interior of the housing.

The collection container 121 can be detected, for example, by providing each collection container 121 with a key formation, for example a projecting lip, and providing the device 100 with a corresponding key formation, for example an insertion slot for the lip, in which case the device 100 is also provided with detection means which determine whether the key formation of the collection container corresponds to the key formation of the device.

In a variant which is not shown, there are stirring means for stirring/mixing the portions of hair dye which have been dispensed into the collection container 121. In one possible embodiment, the stirring means may comprise one or more stirring members which are provided at each collection container 121, and the said device may be provided with drive means for driving the stirring members.

The device 100 is preferably provided with an electronic memory in which a plurality of formulations for mixtures which are to be produced from the substances can be stored. In this case, the device 100 may be provided with a keyboard or other input means which is used to select the desired formulation.

Preferably, the control means of the device 100 also comprise a portable control unit, in which case wireless transmission means are provided for data transmission between the portable control unit and the control means which are accommodated in the device. In this case, the hairdresser can remain with the customer when selecting the desired formulation and simply has to take the collection container 121 out of the device 100 after the mixture has been made up.

In an advantageous embodiment, the portable control unit is provided with reading means for reading information stored on a separate carrier which is to be presented to the control device. For example, each customer has a magnetic card or chip card in which, for example, the formulation (used last) for the said customer is stored.

To ensure that the hairdresser is able to make up a specific hair dye when desired, it is possible for there to be an additional magazine, for example a special cabinet, for storing storage containers 30, in which case the additional magazine is provided with stock-control means for keeping up to date with the stock of storage containers which are present in the magazine. The stock-control means are preferably designed to automatically pass on an order for storage containers to a supplier.

Preferably, the device 100 is also provided with an ejector mechanism for ejecting a storage container which is empty or needs to be changed, for example via an opening in the top side of the housing of the device 100, which can be closed off by a flap. The said opening is then situated above an ejector station where the ejector mechanism is arranged. The ejection and installation of a storage container via the opening are preferably detected automatically.

FIG. 4 shows a telescopic pump component 1 which is provided with a self-closing valve assembly 2.

The pump component 1 is made from suitable plastic material and has a bottom cylindrical annular wall 3 with a stop rim 4 along the outer circumference. A radial annular wall 5 which forms the transition to a top cylindrical annular wall 6 with a smaller diameter than the bottom annular wall 3 is integral with the annular wall 3. At its free end, the top annular wall 6 is provided with an inwardly projecting rim 7 which delimits a circular opening in the pump component 1. The self-closing valve assembly 2, which is to be described in more detail below, is positioned in this opening.

The valve assembly 2 comprises a central, stationary body 9 with a free end which is delimited by an end face 10 of the stationary body 9 and with a sealing surface 11 in the vicinity of the free end. The sealing surface 11 extends around the periphery of the stationary body 9 and in this case adjoins the end face 10. The free end of the stationary body 9 is in this case frustoconical, so that the sealing surface 11 forms a ring segment of a conical surface.

The valve assembly 2 also comprises an elastic annular valve body 12 which extends around the stationary body 9 and, on its inner periphery, has a sealing surface 13 which can bear in a sealed manner against the sealing surface 11 of the stationary body 9. The sealing surface 13 is in the form of a ring segment of a conical surface which corresponds to the sealing surface 11.

On its outer periphery, the valve body 12 is fixed to the pump component 1 in a manner which is yet to be described in more detail.

The valve assembly 2 is such that the end face 10 forms a continuous, smooth surface with the outer surface of the valve body 12 around it and even with the outer surface of the rim 7.

In the embodiment which is shown, this continuous surface forms a part of an outwardly curved convex segment with a radius which is considerably larger than the diameter of the valve body 12.

The stationary body 9 is integral with an insert 15 which is clamped securely in the annular wall 6. In this case, the valve body 12 is provided on its outer periphery with a thick peripheral rib 16 which is enclosed between the insert 15 and the inwardly projecting rim 7.

The insert 15 is provided with a central axial passage 17 which lies in line with the more or less pin-shaped body 9, which passage 17 is connected to a plurality of passages 18 which are formed in the insert 15 from the other side. There are then transverse webs between the said passages 18, so that the body 9 is integral with the insert 15. In this example, the insert 15 is also made from plastic.

At its end which faces the body 9, the insert 15 is provided with an annular groove 19.

The valve body 12 is preferably made from a suitable plastic material, for example based on silicone.

If there is sufficient pressure on the inner surface 20 of the valve body 12, the said valve body 12 will be deformed and a gap will form between the sealing surfaces 11, 13, so that the substance can be dispensed to the outside. When the pressure of the substance drops, the elasticity of the material of the valve body 12 causes the valve to close.

FIG. 5 shows a diagrammatic longitudinal section through a container 30 with an integral pump 31 which is provided with the telescopic pump component 1 shown in FIG. 4. The pump component 1 is in this case guided telescopically in an outermost annular wall 32 of the housing of the pump 31, which annular wall 32 has an inwardly projecting stop rim 33 in the vicinity of its free end. By interacting with the rim 4, the rim 33 delimits the outermost position of the pump component 1.

The container 30 also has a storage chamber 35 for the substance, in particular hair dye, which is delimited by a peripheral wall 36, a closure wall 37 which is fixedly connected thereto and in which there is an opening 38, and, opposite the fixed closure wall 37, a piston 39 which can move in a sealed manner with respect to the peripheral wall 36.

The peripheral wall 36 and the fixed closure wall 37 are produced integrally with the annular wall 32 from a suitable plastic material in an injection molding process.

In the opening 38 there is a suction valve 40, which valve 40 closes in the direction of the storage chamber 35 in a known way.

Between the telescopically moveable pump part 1 and the fixed closure wall 37 there is an elastic bellows 41, which bellows 41 forms an internal variable pump chamber 42. This pump chamber 42, via the valve 40, adjoins the storage chamber 35 and is in open communication with the passages 17, 18 which form the dispensing channel of the pump 31.

The action of the pump with bellows 41 is known from the prior art and requires no further explanation at this point. During actuation, it is sufficient to press on the annular wall 5 in order in this way to dispense substance from the container 30. During the subsequent return movement of the pump component 1, substance is sucked out of the storage chamber 35. The piston 39 then moves towards the fixed closure wall 37.

The presence of the valve assembly 2 at the outer end of the dispensing channel 17, 18 prevents air from entering the said channel and thus causing degradation, drying or oxidation of the substance. As has been stated, this is highly advantageous, for example, for hair dye.

The pump 31 is of simple structure, which makes it acceptable to use the container 30 as a disposable container. In a variant, it is possible for the pump 31 to be detachable from that part of the container 30 which has the storage chamber 30.

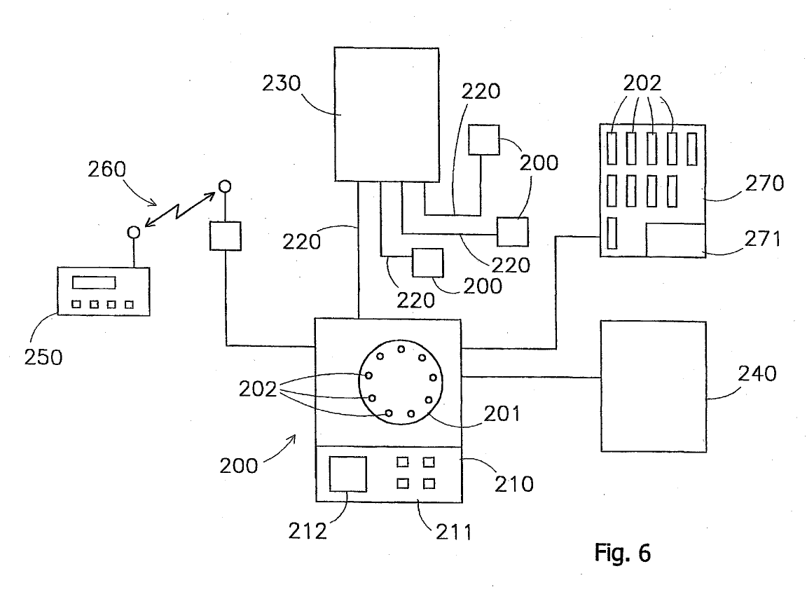

For an explanation of FIG. 6, it is assumed that the system shown is used in the field of hair dyeing. As has been mentioned above, other application areas are, of course, also possible, such as skin treatment but also industrial applications.

The block diagram in FIG. 6 shows a plurality of devices 200, for example at different locations, such as in each case one device 200 in a hairdressing salon. Each device 200 is designed to dispense metered portions of various substances for making up a hair-dye mixture.

Each device 200 comprises a magazine 201 which is provided with a plurality of receiving stations, each of which is designed to receive an exchangeable storage container 202 which has a storage chamber which is filled with a substance. Furthermore, each device 200 comprises dispensing means (not shown) for dispensing substance into a collection container via a dispensing nozzle.

Each device 200 has a computer system 210 which forms part of the control and actuation of the device 200 and also serves for data communication with equipment connected to the device 200. At the computer system 210 of each device 200 there is an input means 211, for example a keyboard, and a display 212.

Each device 200 is also provided with volume-detection means for detecting the volume of substance present in each of the storage containers 202. At these volume-detection means there is a memory, in the computer system 210, for storing the detected volume of each storage container 202. On this basis, the computer system 210 can, for example, determine whether the volume which is present is still sufficient to produce a specific mixture or that a new storage container 202 needs to be put into the device 200. It is also possible to determine the consumption of a specific substance from this volume detection.

The system also comprises a network 220, for example the Internet, to which the computer systems of the dispensing devices 200 are connected.

The system also comprises a central computer system 230 which is connected to the network 220 and, via the network 220, can exchange data with each of the connected dispensing devices 230.

The system also comprises a hair analysis appliance 240 which can be used to analyze the hair of the customer in order to determine the correct dyeing treatment.

The system also comprises a remote control unit 250, which in an expedient embodiment is portable and can be carried by the hairdresser or in an alternative embodiment is positioned at the hairdresser's chair. Furthermore, there are wireless transmission means 260 for data transmission between the remote-control unit 250 and the computer system 210 of the dispensing device 200.

The system also comprises an additional storage magazine 270 for storing storage containers 202. The additional storage magazine 270 is provided with stock-control means 271 for keeping up to date with the stock of storage containers 202 which is present in the magazine 270. A stock-control computer forms part of the stock control means 271 and is connected to the computer system 210 of the associated device 200.

The central computer 230 is in turn connected to the supplier and/or producer of the storage containers filled with substance or is managed by the said supplier/producer.

Inside a hairdressing salon, there is a dispensing device 200 and, depending on the size of the hairdressing salon, the peripherals described above.

The system comprises a formulation memory, for example in the computer system 210 of each device 200 or in the central computer 230, in which a plurality of formulations for mixtures to be produced from the substances are stored.

The system provides one or more algorithms for adapting the formulations stored in the memory as a function of one or more parameters, for example customer-specific parameters, or parameters determined by the hair analysis appliance.

The system provides for the customer's hair to be analyzed using the appliance 240 and for the computer system then to select a suitable formulation from the formulation memory and, if appropriate, to adapt this formulation on the basis of an algorithm in order to obtain an optimum formulation.

The system also comprises adjustment means for the hairdresser to adjust the formulation suggested by the system, so that the hairdresser can apply his specialist knowledge.

The system comprises a logbook memory in which, for each specific customer in a hairdressing salon, it is possible to store which formulations have been dispensed at which times. The logbook memory provides the hairdresser with an insight into the treatments. Furthermore, the hairdresser can choose to repeat a treatment which has already been carried out, so that there is no need to generate a new formulation. The logbook memory may be situated in the computer system 210 or in the computer 230 or in a customer-specific information carrier which the customer possesses.

The system also comprises a diary in which dispensing deliveries of formulations which are planned for the future are planned. In the case of a hairdressing salon, appointments with the customers will be listed in the diary and it will be stated whether a hair-dyeing treatment is desired. In combination with the logbook memory, if this is not merely recorded in the customer-specific information carrier, the system can then predict the formulations which will probably have to be made up in future, although the customer may, of course, decide differently at any time.

The system is designed to compare the planned or predicted dispensing deliveries with the storage containers 202 which are present in the device 200. The system has signaling means, in this case provided by the computer 210, which indicate if the planned or predicted dispensing deliveries cannot be achieved using the storage containers 202 which are present in the device 200, so that the hairdresser can change the storage containers 202 in good time, for example at the beginning or end of the working day.

The information relating to the planned and predicted dispensing deliveries, as well as information relating to the consumption of the substances in the storage containers 202 in the magazine 201, can also be linked by the system to the insight into the stock of storage containers 202 obtained using the stock-control means 271.

The system provides for (semi-)automatic transmission of an order for storage containers 202 to computer 230 belonging to the supplier via the network 220. In the semi-automatic design, the system suggests an order to the hairdresser, which can then be adapted by the hairdresser and transmitted to the supplier after authorization.

The system also comprises a memory for storing an authorization for each dispensing delivery of a formulation, in particular by a customer undergoing, the hair-dyeing treatment. A memory is also provided for storing a customer's order to change the formulation from a formulation suggested by the hairdresser or by the system.

The supplier/producer of the substances can acquire an up to date insight into the demand for the various substances via the computer 230 and can use this information for optimized planning. In combination with the diary function, it is even possible to obtain an insight into future demand.

If use is made of a customer-specific information carrier, the remote-control unit 250 may be provided with reading means for reading the information carrier and/or with writing means for writing new or altered information to the information carrier.

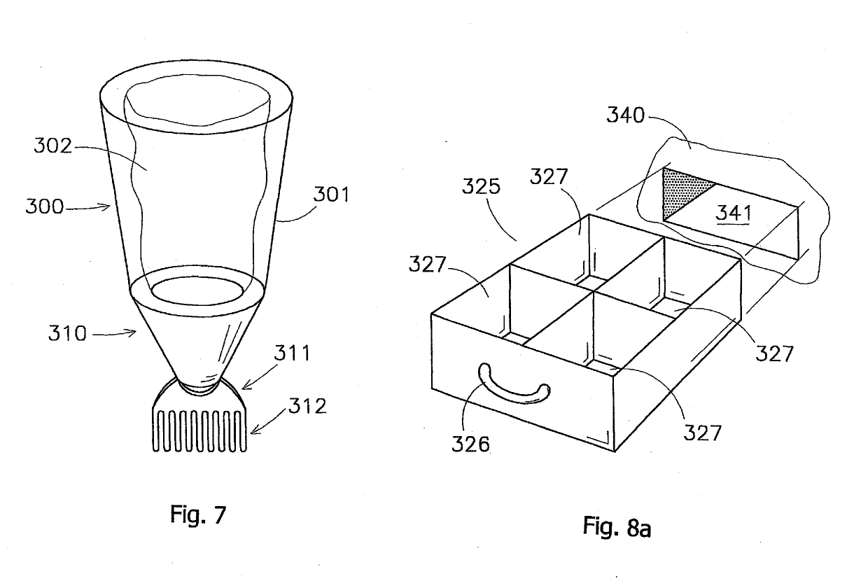

FIG. 7 shows a collection container 300 for a hair-dye mixture. The figure also shows an application member 310 which can be held in the hairdresser's hand. The application member 310 has a comb section 311 with hollow teeth 312.

The collection container 300 is designed to be connected to the application member 310 after it has been filled with the substance(s) and the said substances have been mixed, for example by the device 100, in such a manner that the hair-dye mixture can be applied to the hair via the application member 310, in this case by the hollow teeth 312.

The application member 310 is preferably provided with means for removing the hair-dye mixture from the collection container 300, for example a piston which can be used to force the mixture out of the collection container 300.

The collection container 300 has a stable outer shell 301 and a covering 302 which lines the outer shell 301 at least on the inner side, in such a manner that the substance does not come into contact with the outer shell 301. The covering 302 can be detached from the outer shell 301 so that after use the soiled covering can be removed and a new covering can be placed into the outer shell.

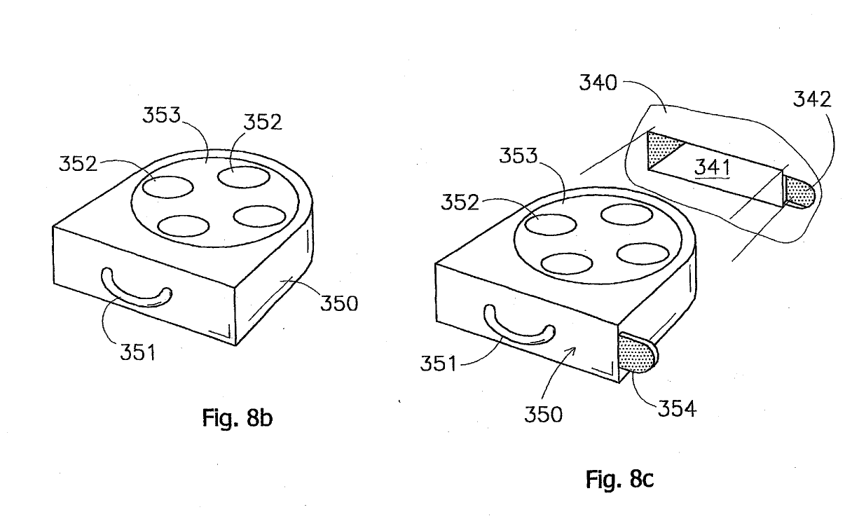

FIG. 8a shows a collection container 325 with handle 326 which is provided with a plurality of separate compartments 327, each intended to receive one or more substances which are to be mixed.

Furthermore, FIG. 8a shows part of the external housing 340 of a dispensing device 100, 200 for the substances, in which part 340 there is an insertion opening 341 for the collection container 325.

The system is provided with positioning means for positioning a compartment 327 of the collection container 325 with respect to a dispensing nozzle of a storage container accommodated in a moveable magazine of the device 100, 200. In this case, it is possible for a storage container to be moved to different dispensing stations, in each case above a compartment of the collection container 325, by means of the movement of the magazine.

FIG. 8b shows another collection container 350 with handle 351 and with a plurality of compartments 352. The compartments 352 are in this case accommodated moveably in the collection container 350, in such a manner that the positioning of a compartment 352 with respect to a dispensing nozzle of a storage container in the device 100, 200 can be effected by suitable movement of the compartments 352. In this example, the compartments 352 are accommodated in a common turntable 353.

FIG. 8c shows a variant of the collection container 350, as well as the wall 340 and insertion opening 341 of the dispensing device (not shown in more detail).

The collection container 350 is provided with a key formation 354, in this example a projecting lip. The dispensing device is provided with a complementary key formation 342, in this example an insertion opening for the lip. The dispensing device is also provided with detection means, for example a switch, which detect whether the key formation 354 of the collection container is located in the insertion opening 342. This allows the presence of the collection container 350 at the dispensing station of the dispensing device to be determined.

The dispensing device is provided with a moveable magazine for the storage containers holding substance. The associated drive means of the magazine are inactive if the detection means do not detect a collection container 350. Consequently, it is impossible for an object, for example a hand or fingers, which is inserted into the housing through the open opening 341 if there is no collection container in the said insertion opening 341, to become trapped or jammed.

The dimensions of the collection container 350 with respect to the insertion opening 341 in the wall 340 of the housing of the dispensing device are such that it is impossible for the hand or one or more fingers to gain access to the interior of the housing when the collection container is situated in the insertion opening. The collection container 350 preferably fits into the insertion opening 341 with only a slight clearance.

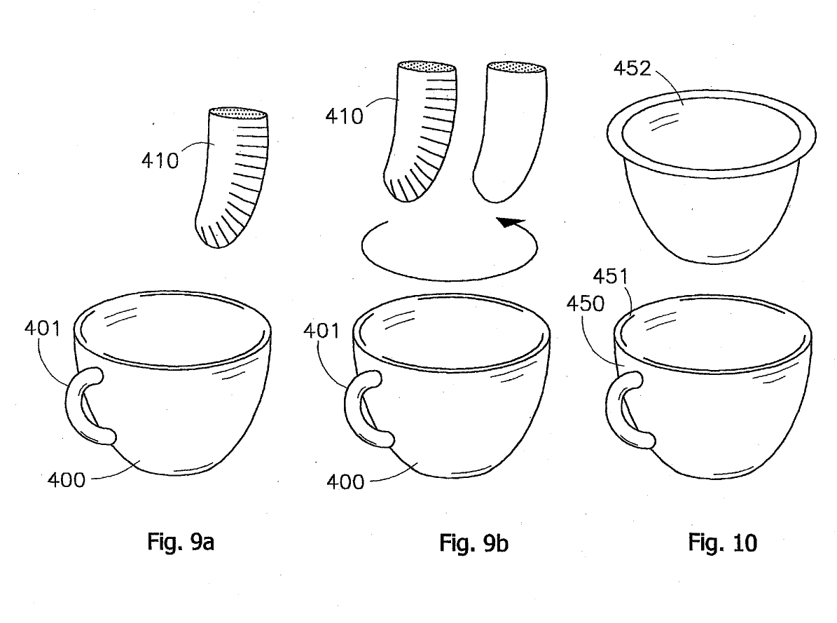

FIGS. 9a, 9b relate to the stirring of the substances in the collection container.

FIG. 9a shows a collection container 400 with handle 401. To make up a hair-dye mixture, a plurality of substances are introduced into the collection container 400, and the substances are then to be mixed.

Reference numeral 410 indicates a stirring member which is designed as a comb, which comb, after the stirring, can also be used as an application member for applying the mixture to the hair of the customer.

In one possible embodiment, the collection container 400 is held in a stationary position in the dispensing device 100 and the device 100 is provided with drive means for moving the stirring member 410 with respect to the collection container, so that the substances in the collection container 400 are mixed.

In a variant shown in FIG. 9b, it is the stirring member 410 which is held in a stationary position, and drive means are provided for the purpose of moving the collection container with respect to the stirring member 410. If appropriate, a plurality of stirring members are provided.

If the collection container has a covering as described with reference to FIG. 7, it is possible for the covering to be moved while the stable outer shell remains stationary.

In another variant (not shown), the stirring member and the associated stirring means are designed for contactless, for example magnetic, driving of the stirring member.

In another variant, the drive means for the collection container are designed to shake the collection container or carry out some similar action, and the stirring member is an element which is accommodated moveably in the collection container. This results in the intended mixing.

FIG. 10 shows a collection container 450 with a stable outer shell 451 and a covering 452 which lines the outer shell 451 at least on the inner side, in such a manner that the substance does not come into contact with the outer shell 451. The covering 452 can be detached from the outer shell 451, so that after use the soiled covering can be removed and a new covering can be placed in the outer shell.

The covering 452 is made, for example, from a thin-walled plastic, as is known, for example, from a butter tub.

in connection with stirring of the mixture in the collection container 450, it is also possible for the covering 452 to form agitation formations, for example formations which are distributed around the periphery and project inwards, in such a manner that in the event of movement, in particular rotation, of the collection container or the covering 452, the substances in the collection container 450 are agitated and mixed with one another.

The agitation formations may be formed, for example, by providing the peripheral wall of the covering with an undulating profile or inwardly projecting baffles.

FIG. 11 relates to the mixing of a highly viscous or pasty substance, such as hair dye, with a low-viscosity substance, such as for example hydrogen peroxide or some other diluent.

FIG. 11 shows a storage container 500 which is filled with hair dye and is accommodated in a moveable magazine (not shown in more detail) of a dispensing device. This dispensing device comprises drive means for moving the magazine, in such a manner that one of the storage containers 500 can be moved to a dispensing station of the device for the purpose of dispensing hair-dye substance into a collection container arranged at the dispensing station via a dispensing nozzle 501 of the storage container 500.

Furthermore, one or more storage containers filled with hydrogen peroxide are accommodated in the dispensing device.

The dispensing device is provided with one or more jet nozzles 503 and an associated feed mechanism for dispensing a powerful jet 504 of the hydrogen peroxide towards a stream 505 of hair dye coming out of the dispensing nozzle 501. As a result, mixing takes place under the influence of collisions between the jets 504 and the stream 505. This mixing may be sufficient to allow the hair-dye mixture to be applied to the hair, but it is also possible to provide for a following mixing phase, for example using the stirring methods described above.

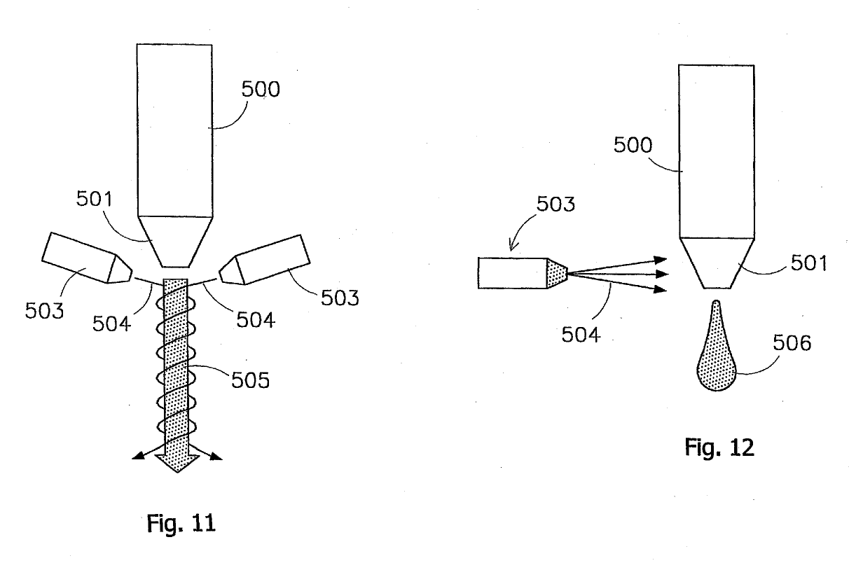

FIG. 12 relates to the cleaning of the dispensing nozzle of a storage container from which a highly viscous substance, such as for example hair dye, is dispensed.

The figure shows the storage container 500 with dispensing nozzle 501 and a jet nozzle 503, from which a jet of a low viscosity substance, such as hydrogen peroxide, directed towards the dispensing nozzle is dispensed, in the direction of the dispensing nozzle 501. This jet 503 makes it possible to prevent a residue of the highly viscous substance being left on the dispensing nozzle. Particularly in the case of hair dye with a jet of hydrogen peroxide, this cleaning method has been found to function successfully. The drop 506 represents the residue which has been removed.

The cleaning of the dispensing nozzle 501 may take place at the dispensing station of the dispensing device (not shown) where the substance is dispensed to the collection container. If the storage container 500 is accommodated in a moveable magazine, it is possible to provide a separate cleaning station along the path of the dispensing nozzles 501 of the storage containers 500.

FIG. 14 relates to the mating connection between a collection container and the dispensing nozzle of a storage container.

FIG. 14 shows part of a storage container 30 which is accommodated, for example, in the magazine of the device 100 (not shown).

In the illustration shown in FIG. 1, there is a risk that hair-dye substance which has been dispensed will not pass into the collection container, but rather will be deposited next to it. This is undesirable. Furthermore, it is easy for vapors to escape, and inhalation of these vapors should preferably be reduced as far as possible.

FIG. 14 shows a collection vessel 650. A cover 651 with an opening 652 rests on the collection vessel 650. The dispensing nozzle of the storage container 30 can fit through this opening 652.

When substance is being dispensed into the collection container 650, the cover 651 ensures that the dispensing nozzle is situated in a space which is sealed off from the outside atmosphere and is at least partially delimited by the collection container 650, so that when substance is fed to the collection container 650 there is no leakage of substance and/or vapor to the outside atmosphere.

It will be clear that the cover 652 may be a separate cover, but the cover 652 could also form part of the collection container, so that a collection container which is provided with a connection piece which can be connected to the dispensing nozzle is obtained. The connection piece then preferably fits accurately onto the dispensing nozzle.

Preferably, the connection piece of the collection container can also be connected to an application member for applying the substance or the mixture of substances to the surface, for example to the hair.

In a variant which is not shown, there is a collection-container valve for closing off the connection piece, preferably a self-closing valve, in such a manner that, by closing the valve, it is possible to prevent substance from escaping from the collection container.

The collection-container valve is preferably of the type which opens when the connection piece is connected to the dispensing nozzle and closes automatically when the connecting piece and the dispensing nozzle are detached from one another.

In a variant which is not shown, the collection container could also be designed as a flexible bag with a connection piece, optionally provided with a valve, for connecting the bag to a storage container during filling of the bag and to an application member for dispensing the substance or the mixture of substances. By way of example, it is possible for the mixing of a plurality of substances in the bag to take place by kneading the bag by hand or using a kneading mechanism. In this case, the application member is, for example, provided with a mechanism for squeezing it empty or a pump for extracting the substance from the bag.

In another variant, the bag with connection piece for the collection container is accommodated in a stable outer shell.

We claim:

1. An apparatus for dispensing a plurality of fluids, comprising:
a turntable; and
a plurality of pumps, each connected to a container, the pumps and containers being mounted on the turntable arranged along the circumference of the turntable or part of the circumference of the turntable,
wherein at least one of the containers has a larger volume than the other containers or is in fluid connection with a further container positioned towards or at the center of the turntable.

2. An apparatus for dispensing a plurality of fluids, comprising:
a turntable;
a plurality of first containers being mounted on a turntable and arranged along at least a portion of a circumference of the turntable;
at least one second container having a larger volume than the plurality of first containers, the at least one second container being positioned and arranged towards or at the center of the turntable; and
each container having an associated pump mounted thereto for the dispensing of fluid contained within each container.

3. An apparatus for dispensing a plurality of fluids, comprising:
a turntable;
a plurality of first containers mounted along a circumference of the turntable;
at least one second container having a larger volume than the plurality of first containers; and
each container, of the plurality of first containers and at least one second container, having an associated pump mounted thereto for dispensing fluid contained in each container.

4. The apparatus of claim 3, wherein the at least one second container is positioned towards or at the center of the turntable.
